(19) United States
(12) Patent Application Publication
(10) Pub. No.: US 2017/0198818 A1
(43) Pub. Date: Jul. 13, 2017

(54) DRAIN FITTING FOR A PORTABLE TANK

(71) Applicant: Richter Chemie-Technik GmbH, Kempen (DE)

(72) Inventor: Manfred SETT, Kempen (DE)

(21) Appl. No.: 15/375,884

(22) Filed: Dec. 12, 2016

(30) Foreign Application Priority Data
Jan. 7, 2016 (DE) 102016000081.3

(51) Int. Cl. F16K 5/06; F16K 15/18; F16K 31/60; F16K 15/03; F16K 27/06

(52) U.S. Cl. CPC F16K 5/0657; F16K 15/03; F16K 27/067; F16K 31/602; F16K 15/181

(57) ABSTRACT

A drain valve for a portable tank has a flange securable externally to a wall of the tank and formed with a hole centered on a flange axis perpendicular to a face of the flange. A housing extends from the flange and forms a housing flow passage extending along a passage axis opening into the tank at the hole of the flange and forming an angle of less than 90° with the flange axis. A ball valve element in the housing at the housing flow passage is movable between an open position permitting flow through the housing flow passage and a closed position blocking such flow. A shaft journaled in the housing is fixed to the ball valve element and extends along a shaft axis substantially perpendicular to the passage axis. An actuator connected to the shaft outside the housing is operable to pivot the ball valve element about the shaft axis between the open and closed positions.

### FIELD OF THE INVENTION

The present invention relates to drain fitting for a tank. More particularly this invention concerns a drain valve used on a portable tank.

### BACKGROUND OF THE INVENTION

A portable tank, typically made of stiff but somewhat flexible plastic, is normally provided with a drain valve forming a flow passage and having a valve housing secured externally on an opening in a tank side wall by a connection sleeve and a flange such that a center axis of the flange forms an angle not equal to 90° with the axis of the flow passage. The fitting is secured to a side wall adjacent the floor, and some times even to the floor.

To empty a portable tank it is known from DE 60 121 617 to attach a fitting having a valve to the front wall of the tank near the tank base. This valve is actuated by an S-shaped lever that may jam in certain cases and has a complex, multipart structure.

### OBJECTS OF THE INVENTION

It is therefore an object of the present invention to provide an improved drain fitting for a portable tank.

Another object is the provision of such an improved drain fitting for a portable tank that overcomes the above-given disadvantages, in particular that is of simple design and that has a high level of functional and operational reliability.

### SUMMARY OF THE INVENTION

A drain valve for a portable tank has according to the invention a flange securable externally to a wall of the tank and formed with a hole centered on a flange axis perpendicular to a face of the flange. A housing extends from the flange and forms a housing flow passage extending along a passage axis opening into the tank at the hole of the flange and forming an angle of less than 90° with the flange axis. A ball valve element in the housing at the housing flow passage is movable between an open position permitting flow through the housing flow passage and a closed position blocking such flow. A shaft journaled in the housing is fixed to the ball valve element and extends along a shaft axis substantially perpendicular to the psssage axis. An actuator connected to the shaft outside the housing is operable to pivot the ball valve element about the shaft axis between the open and closed positions. The valve body is spherical valve body and has a throughgoing passage extending transversely with respect to the shaft that actuates the valve body.

A ball valve ensures that the valve cannot jam in any situation, so that a high level of functional reliability is provided. A ball valve can also be operated simply by hand, without requiring external energy for actuation. Furthermore, a simple design using few parts is provided.

In case of a tank with a curved front wall, in order to attach the fitting according to the invention in the lowermost region, the angle the flange axis forms with the axis of the flow passage is 30° to 60°, preferably 45°.

Particularly simple and reliable operation of the fitting is ensured if a shaft extension is fastened to the outer end of the actuating shaft of the valve body by an articulated joint, in particular by a universal joint.

In this case the base fitting can be surrounded by a protective housing, and the actuating shaft of the valve body or an extension of the actuating shaft passes through a wall of the housing. Thus the base fitting can be operated simply and quickly without the need to access the interior of the housing.

Particularly simple and reliable operation of the fitting is ensured if an actuating lever or arm that can be manually actuated is fixed on and extends transversely of an axis of the actuating shaft at an outer end of the actuating shaft of the valve body or an extension of the actuating shaft. In this case the actuating lever may have a locking device.

In order to reliably prevent corrosion of a fitting by corrosive media, the spherical valve body has an outer shell made of a chemical-resistant plastic, in particular perfluoroalkoxyalkane (PFA). Furthermore, it is advantageous, in this connection, if the valve housing is provided with a chemical-resistant lining made of a plastic, in particular perfluoroalkoxyalkane (PFA). The spherical valve body may be guided between two replaceable seat rings made of a chemical-resistant plastic. The use of PFA has the considerable advantage that in cold conditions the material does not become hard or brittle, as is the case with elastomers.

It is particularly advantageous if, on a side turned away from the tank, the base fitting is connected to a secondary shut-off fitting. As a result, it is possible to simply and quickly deal with wear. The reliability of the base fitting is increased if the secondary shut-off fitting is a flap valve.

### BRIEF DESCRIPTION OF THE DRAWING

The above and other objects, features, and advantages will become more readily apparent from the following description, reference being made to the accompanying drawing in which:

FIG. 1 is a section along I-I in FIG. 2, and

FIG. 2 is a section along II-II in FIG. 1.

### SPECIFIC DESCRIPTION OF THE INVENTION

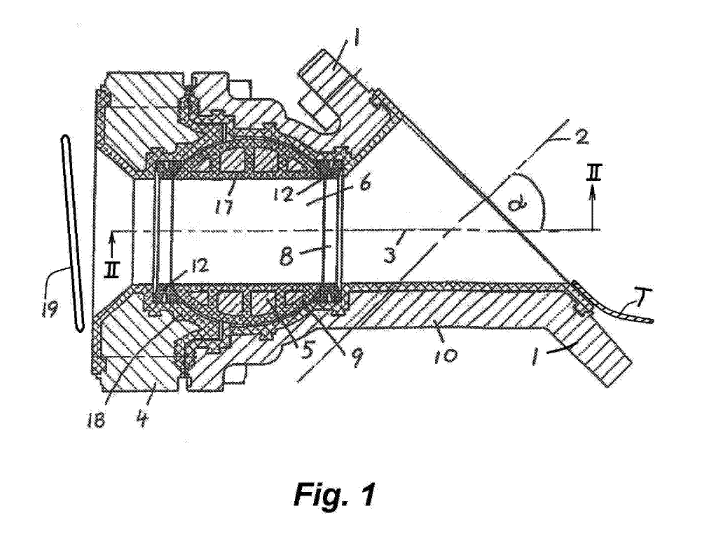

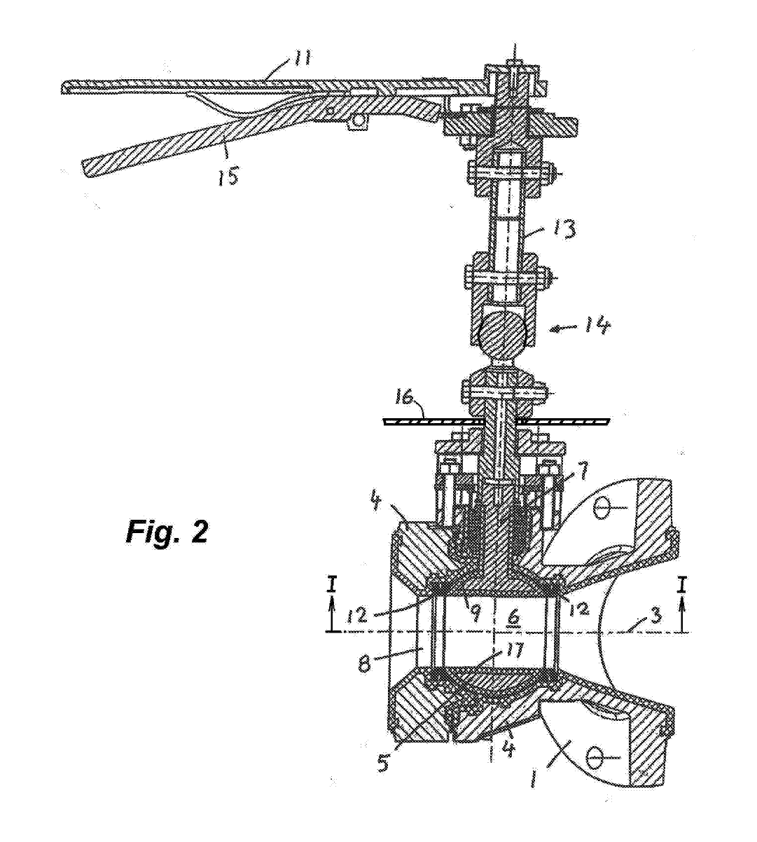

As seen in FIGS. 1 and 2, in order to be able to empty a tank shown schematically at T, a base fitting is fastened to a front wall of the tank T in the base region thereof. Normally, in this case, the front wall of the tank T has a part-spherical and outwardly convex shape, so that in the lower region of the tank inside the bottom the tank wall extends at an acute angle of 30° to 60° to the horizontal. In order to be able to fasten a base fitting to such an oblique wall region of the tank T, the base fitting has a flange 1 that is set, like the tank wall, at an angle of 30° to 60°, in particular at an angle of 45° to the horizontal so that a flange axis 2 forms an angle α of 30° to 60°, preferably 45°, with a center axis 3 of a cylindrical flow passage 8 of the fitting, as shown in FIG. 1. This flange axis 2 extends perpendicular to the outer face of the flange 1 and through the center of a center hole of the flange 1.

The base fitting has a ball valve with a spherical valve body 5 rotatably supported inside a valve housing 4 formed unitarily with a connection nipple 10 carrying the flange 1. The valve body 5 has a throughgoing cylindrical passage 6 that extends transversely with respect to a shaft 7 that actuates the valve body 5. In the open position of the valve body 5 the throughgoing passage 6 is aligned coaxially with the flow passage 8 of the valve housing 4 and forms a smooth continuation thereof. In the closed position this passage 6 is transverse to the passage 8 and flow through the passage 8 is impossible.

In order to let aggressive, corrosive media flow through the base fitting, the spherical valve body 5 has on its outer face an outer shell 9 made of perfluoroalkoxyalkane (PFA). In this case the throughgoing passage 6 of the valve body is also lined with a layer 17 of PFA. Furthermore, the valve housing 4 is also provided with a lining of PFA in the flow passage 8 and the connection sleeve 10 leading to the flange 1 so that the spherical valve body 5 moves inside the lining 17 of the valve housing 4.

A pair of coaxial seat rings 12 made of a resistant plastic, in particular PTFE, are aligned on the axis 3 of the flow passage 8 and coaxially flank the valve body 5.

The shaft 7 extends along a shaft axis 18 intersecting the passage axis 3 at an angle of 90°, extending out of the valve housing 4, and is formed on the spherical valve body 5. A shaft extension 13 is fastened to the actuating shaft 7 by a universal joint 14 and extends through a wall of a housing 16 surrounding the base fitting. An actuating lever 11 that can be operated manually is fastened to the outer end of the shaft extension 13 and has a locking lever 15, for retaining the actuating lever in the required position.

On a side turned away from the tank, the base fitting is connected to a secondary shut-off fitting that preferably is a flap valve shown schematically in FIG. 1 at 19.

I claim:

1. A drain valve for a portable tank, the valve comprising:
a flange securable externally to a wall of the tank and formed with a hole centered on a flange axis perpendicular to a face of the flange;
a housing extending from the flange and forming a housing flow passage extending along a passage axis opening into the tank at the hole of the flange and forming an angle of less than 90° with the flange axis;
a ball valve element in the housing at the housing flow passage and movable between an open position permitting flow through the housing flow passage and a closed position blocking such flow;
a shaft journaled in the housing, fixed to the ball valve element, and extending along a shaft axis substantially perpendicular to the passage axis; and
actuating means connected to the shaft outside the housing and operable to pivot the ball valve element about the shaft axis between the open and closed positions.

2. The drain valve defined in claim 1, wherein the angle the flange axis forms with the passage axis is 30° to 60°.

3. The drain valve defined in claim 1, wherein the angle the flange axis forms with the passage axis is substantially 45°.

4. The drain valve defined in claim 1, wherein the angle the flange axis formed with the passage axis is generally 45°.

5. The drain valve defined in claim 1, wherein the means includes:
an extension extending generally along the shaft axis from an outer end of the shaft; and
a universal joint connecting the extension to the outer end.

6. The drain valve defined in claim 5, further comprising
a housing surrounding the valve housing, the means including an extension of the shaft extending out through a wall of the housing.

7. The drain valve defined in claim 5, wherein the means further comprises:
an arm connected to the extension outside the housing and extending transversely of the shaft axis.

8. The drain valve defined in claim 5, further comprising:
means outside the housing for securing the arm against movement in positions corresponding to the open and closed positions of the ball valve element.

9. The drain valve defined in claim 1, wherein the ball valve body has an outer shell made of a plastic that is resistant to chemicals.

10. The drain valve defined in claim 9, wherein the plastic is perfluoroalkoxyalkane.

11. The drain valve defined in claim 1, wherein the valve housing has a lining made of a plastic that is resistant to chemicals.

12. The drain valve defined in claim 11 wherein the plastic is perfluoroalkoxyalkane.

13. The drain valve defined in claim 1, further comprising a pair of replaceable plastic seat rings that are resistant to plastic, that flank the ball valve element diametrally oppositely on the passage axis, and that support the valve ball element in the housing.

14. The drain valve defined in claim 1, further comprising a secondary shut-off fitting on a side of the valve turned away from the tank.

15. The drain valve defined in claim 14, wherein the secondary shut-off fitting is a flap valve.
